(19) United States
(12) Patent Application Publication
(10) Pub. No.: US 2008/0218995 A1
(43) Pub. Date: Sep. 11, 2008

(54) Variable color aquarium lighting

(76) Inventors: Drew Edward Gilkey, Villa Park, CA (US); Richard Jeff Garcia, Yucaipa, CA (US)

Correspondence Address: Drew Gilkey, 18922 El Moro Way, Villa Park, CA, 92861, US

(21) Appl. No.: 12/072,670

(22) Filed: Feb. 27, 2008

Related U.S. Application Data
(60) Provisional application No. 60/903,896, filed on Feb. 27, 2007.

(51) Int. Cl. F21V 33/00

(52) U.S. Cl. 362/101

(57) ABSTRACT

A variable color aquarium lighting system that allows for a naturalistic day and moonlight cycle. The device will mount in the hood of an aquarium and can optionally be suspended above the aquarium by other means. Another embodiment of the device will allow the device to display a selected color.

### CROSS-REFERENCE TO RELATED APPLICATIONS

This application claims the benefit of provisional patent application Ser. No. 60/903,896, filed 2007, Feb. 27 by the present inventors.

### BACKGROUND OF THE INVENTION

1. Field of Invention

This invention generally related to aquariums, specifically to an improved way of providing a natural light cycle to the aquarium.

2. Prior Art

Previously aquarium lighting has been primarily confined to simple white lighting with the only variation being which color temperature of white was used. More recently single color lights have been introduced for decorative purposes; among these single color lights has been blue to simulate a moonlight condition. However these approaches only allow a single color and no coordination between different lights is used to create additional colors. Additionally, aquarium lighting is very limited in how much the intensity can vary; with most aquarium lights not being able to change intensity at all.

This has limited how effectively a natural environment can be modeled since natural light varies in both color and intensity throughout the day and night. From the first glows of morning to the full sun of mid-day to the orange and pink of sunset both the color and intensity varies quite a bit. Given only one or two colors at a fixed intensity the natural environment is not effectively modeled.

Known in the art are the following documents: “Programmable Analog for High Power LED Color Mixing Applications”¹, Cypress Semiconductor/December 2006. While the use of color mixing has been known for a long time, it has never been applied to aquarium lighting until now.

3. Objects and Advantages

Accordingly, several objects and advantages of the invention are:
(a) to provide light for an aquarium that can simulate a natural full day and moonlight cycle;
(b) to provide a selection of color to display decoratively in the aquarium; and
(c) to provide light at different levels of intensity;

Further objects and advantages of our invention will become apparent from a consideration of drawings and ensuing description.

### SUMMARY

The invention pertains to a variable color lighting system to be used in conjunction with an aquarium. This lighting system allows for a full natural day and moonlight cycle. In addition, the system will allow for variable light intensity and color selection.

### DRAWINGS—FIGURES

FIG. 1 is a drawing of the typical embodiment of the light.

FIG. 2 is a drawing of an underside view of an aquarium hood with the invention attached to it.

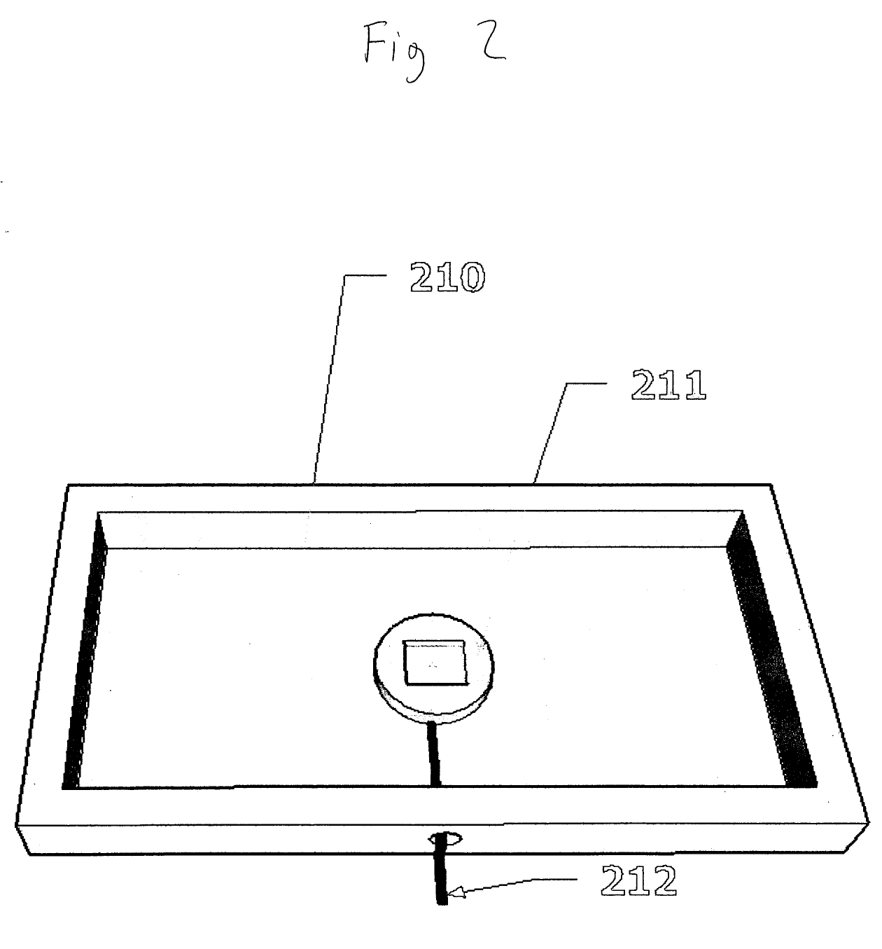

FIG. 3 is an electrical schematic detailing how the invention functions.

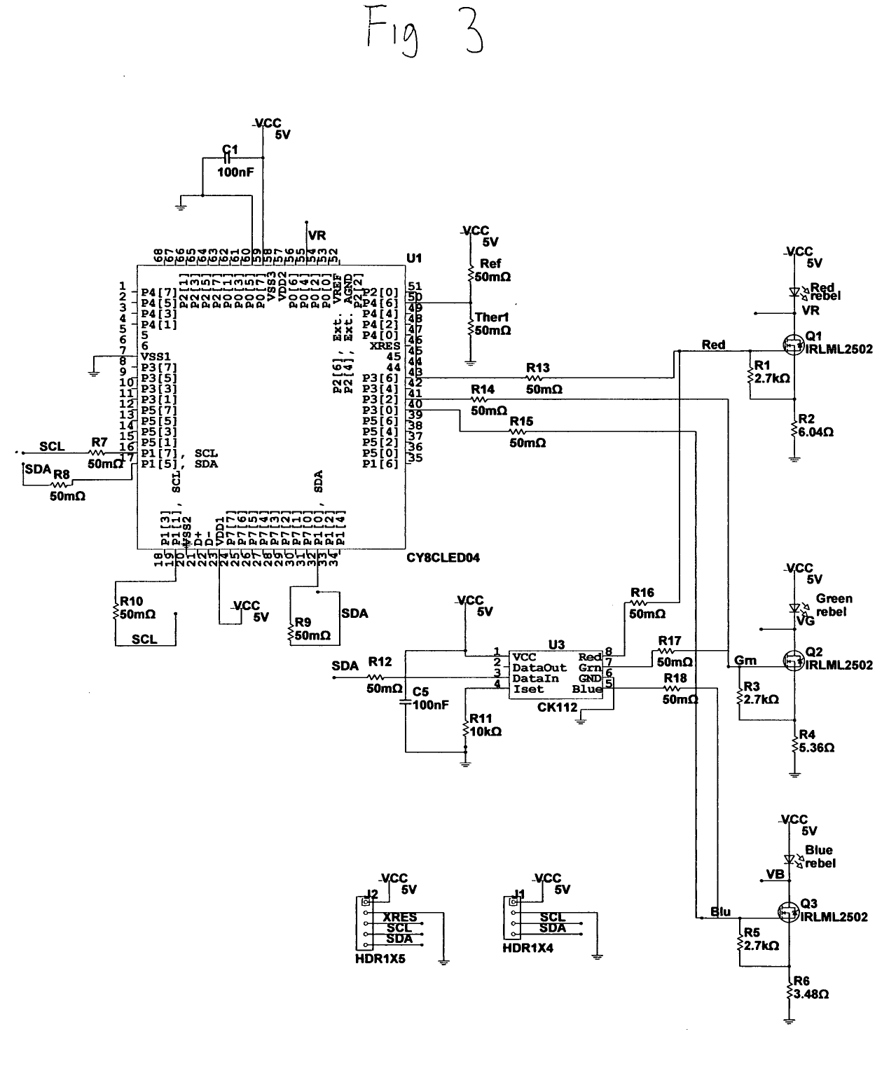

FIG. 4 is a flow chart describing the operation of the microcontroller.

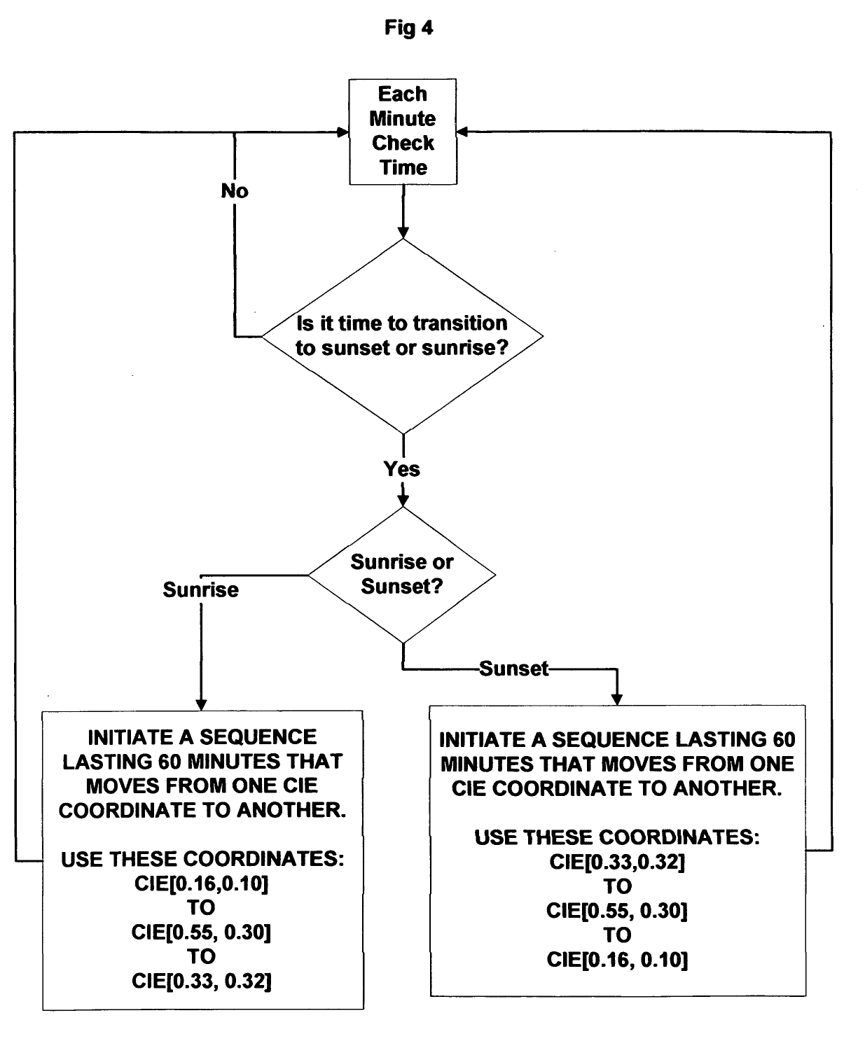

FIG. 5 is a drawing of how the invention will be placed above the aquarium. The device can mount above the aquarium in a hood as shown or suspended by other means.

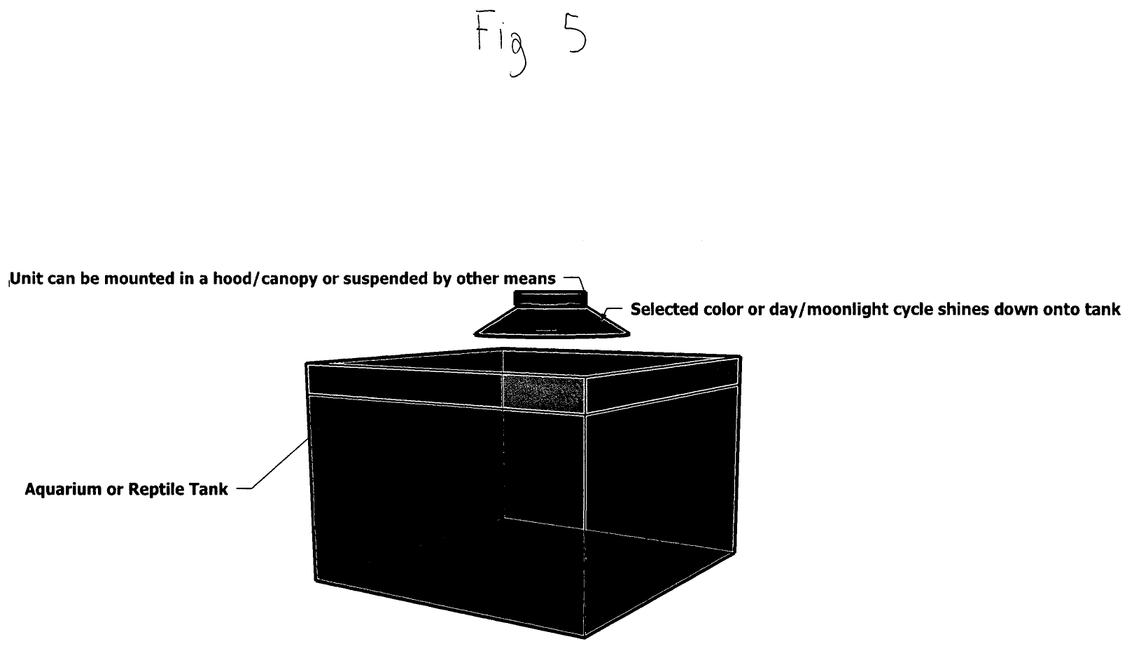

### DETAILED DESCRIPTION

### Preferred Embodiment

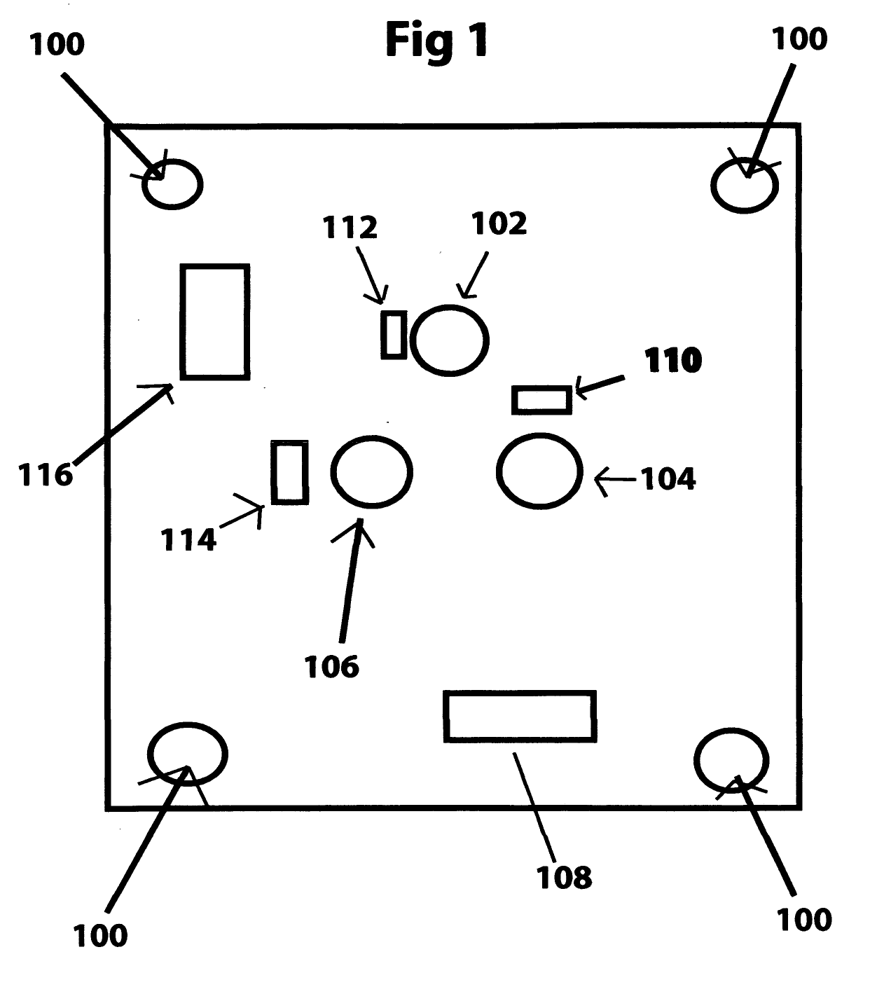

### FIG. 1

The components of the invention are shown in FIG. 1 as:
(a) A lighting board that includes different LED lights, and possibly circuitry needed for the LED lights, and possibly a means to control the LEDs. The board can be optionally mounted using mounting holes 100.
(b) Light sources shown as a red LED 102, green LED 104, and a blue LED 106.
(c) For the most accurate lighting the LEDs can have temperature sensors (110, 112, and 114) to account for the effect of temperature on LED light.
(d) The lights are coordinated using a microcontroller or microprocessor. The microcontroller can either be mounted on the light board (shown as 116) or optionally off board and controlling the lights through a connector 108. The connector 108 also provides power.

The method of wiring and powering the electronic components above and mounting them in a way suitable for an aquarium would be well known to those with ordinary skill in the electronic and mechanical arts. Microcontroller 116 is a standard microchip having a program that allows it to effectively mix the different color LEDs (102, 104, and 106) to create other colors. For better simulation of natural light cycles the microcontroller 116 would have accurate time keeping means.

### Operation of Invention:

The invention achieves its results as follows:
1. The microcontroller 116 controls the different fixed lights (102, 104, and 106) in such as way as to create a different desired light (such as orange, violet, or even white). One way to do this using a Cypress microcontroller is described in an attached application note (Cypress App Note XZY). The lights may be either directly controlled if the microcontroller is on the same board or a connector 108 may be needed. Also, depending on how powerful the lights are additional driving circuitry may be needed. The microcontroller 116 may also interface with the optional temperature sensors (110, 112, and 114) to correct for color shifts that happen to LEDs based on temperature.
2. The colors are changed in a standard sequence to simulate transitions from night to day and from day to night (i.e., sunrise and sunset). Note that both color and intensity can be changed for the best possible simulation of natural light cycles.
3. These cycles are repeated day after day.

The user may, if desired, also use the ability to display different colors to change the color to suite their personal taste instead of simulating natural light cycles. The advantage with our invention over current lighting is that only a few lights are needed yet an incredible diverse set of colors can be created very economically. Color selection is typically implemented with just three lights: red 102, green 104, and blue 106. The microcontroller 116 could cycle between a preset pattern of colors, randomly show different colors, or allow for custom colors and patterns.

### Description and Operation of Alternative Embodiments

There are several alternative embodiments of the invention that can be implemented for aquarium lighting:
(a) Instead of using LEDs a different light generating device can be substituted in place of 102, 104, and 106. The unit in theory should operate the same but with the additional circuitry that is required for the alternative light source.
(b) Alternative methods could include the use of alternative or additional color mixing capable microcontrollers to control the LEDs. The alternative method could be a simple drop in replacement of microcontroller 116 or even an addition that microcontroller 116 can communicate with through whatever means the additional chip requires such as serial communications.
(c) With the removal of the temperature sensors a less expensive model could be fashioned that does not have the same intensity and color mixing accuracy that a model with temperature sensors could achieve.
(d) A light sensor could be added to calibrate the color output of the LEDs more accurately. The light sensor would take readings of the color output and return to the microcontroller a variable that can be used to either calibrate or adjust the LEDs to the appropriate color.

### CONCLUSION, RAMIFICATIONS, AND SCOPE

Accordingly the reader will see that the variable light cycle of the light provides a new method of lighting an aquarium and brings a naturalistic look that would otherwise be left out with the current lighting methods.

While our above description contains many specificities these should not be construed as limitations on the scope of the invention, but rather as an exemplification of one preferred embodiment thereof. Many other variations are possible. For example; a color wheel could be used to rotate a piece of transparent colored plastic over a white light, allowing for the changing of colors via a mechanical method.

Accordingly, the scope of the invention should be determined not by the embodiment(s) illustrated but by the appended claims and their legal equivalents.

We claim:

1. A device for simulating day and moonlight cycles by the use different color LEDs in different intensities for the purpose of aquarium lighting, comprising:
a. A microcontroller to stimulate LEDs through electrical means.
b. A real time clock.
c. Two of more LEDs of different color.

2. The device such as described in claim 1 can also be applied to other pet enclosures that could benefit from day and moonlight cycles such as reptile cages, terrariums, and other pet enclosures.

3. A device such as described in claim 1 in which the incandescent lights are used in place of LEDs.

4. A device such as described in claim 1 in which a color mixing IC is used in place of the microcontroller.

5. A device such as described in claim 1 in which a crystal is used in combination with a microcontroller to keep time.

6. A device such as described in claim 1 in which the unit can be suspended above an aquarium.

7. A device such as described in claim 1 in which the unit can be submerged under water.

8. A device such as described in claim 1 in which the unit can be controlled from an optional source.

9. A device that allows for variable color selection for aquarium lighting; comprising:
a. Two or more LEDs of different color.
b. A microcontroller to stimulate LEDs through electrical means.

10. A device such as described in claim 9 in which incandescent lights are used in place of LEDs.

11. A device such as described in claim 9 in which a color mixing IC is used in place of the microcontroller.

12. A device such as described in claim 9 in which the unit can be suspended above an aquarium.

13. A device such as described in claim 9 in which the unit can be submerged under water.

14. A device such as described in claim 9 in which the unit can be controlled from an optional source.

15. A device such as described in claim 9 in which the unit can be programmed to randomly select colors.
